(19) United States
(12) Patent Application Publication
(10) Pub. No.: US 2010/0235463 A1
(43) Pub. Date: Sep. 16, 2010

(54) SYSTEM FOR COMMUNICATING

(76) Inventor: Michael C. Mayo, Fair Oaks, CA (US)

Correspondence Address: MAIER & MAIER, PLLC, 1000 DUKE STREET, ALEXANDRIA, VA, 22314, US

(21) Appl. No.: 12/403,498

(22) Filed: Mar. 13, 2009

(51) Int. Cl. G06F 15/16

(52) U.S. Cl. 709/217

(57) ABSTRACT

A method and system for communicating. The system and method can include steps for entering contact information and a communication into a database. A communications system capable of accessing the data in the database may use the contact information to contact a recipient or a plurality of recipients. Following the receipt of feedback from the recipients who were contacted and entry of the correct passcode by the recipients who were contacted, the communications system may relay the contents of the communication to the recipients.

### BACKGROUND

Modern communications employ a variety of formats. Wireless telephones, personal digital assistants and other mobile or portable communication devices are capable of sending and receiving voice calls, data calls, SMS messages, email, facsimiles and other data rapidly and securely. Communication through any of these devices allows professionals to remain in contact with their places of employment despite being remotely located and allowing individuals to remain in close contact with others despite geographic differences. In some instances, mobile and portable communication devices are used by people to distribute information to remote recipients.

Modern communication has also allowed people to send information to several recipients. Copies of a single message may be distributed to multiple recipients simultaneously. However, the sender of the message is usually not informed whether the sent message was read by the intended recipients nor which individuals out of multiple recipients had read the message.

### SUMMARY OF THE INVENTION

An embodiment of the invention includes a method of communicating. The method may include a variety of steps, such as entering contact information into a database and entering message contents into a database. The method may have a further step of setting conditions for a communication system associated with the database to communicate with a remotely located communication device as well as communicating with the remotely located communication device by the communication system associated with the database when a first condition is met. The method may then include a step for performing a first action when the remotely located communication device provides an appropriate response to the communication between the communication system associated with the database and the remotely located communication device and then can have a step for performing a second action when the remotely located communication device provides an inappropriate response to the communication between the communication system associated with the database and the remotely located communication device. The method also includes a step for performing a third action when the remotely located communication device fails to provide a response to the communication between the communication system associated with the database and the remotely located communication device.

Another exemplary embodiment may include a system for communication. The system can include database that houses data. The system may also have a first communication device that communicates with the database through a second communication device, the first communication device provides data to the database, the database housing the data provided by the first communication device and a second communication device that accesses data in the database and communicates with the first communication device. In some exemplary embodiments, the second communication device retrieves information from the database and attempts to communicate with the first communication device at predetermined intervals.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing a computer system.

FIG. 2 is an exemplary diagram showing an exemplary communication system.

FIG. 3 is an exemplary flowchart showing a communication methodology.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiment” and “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

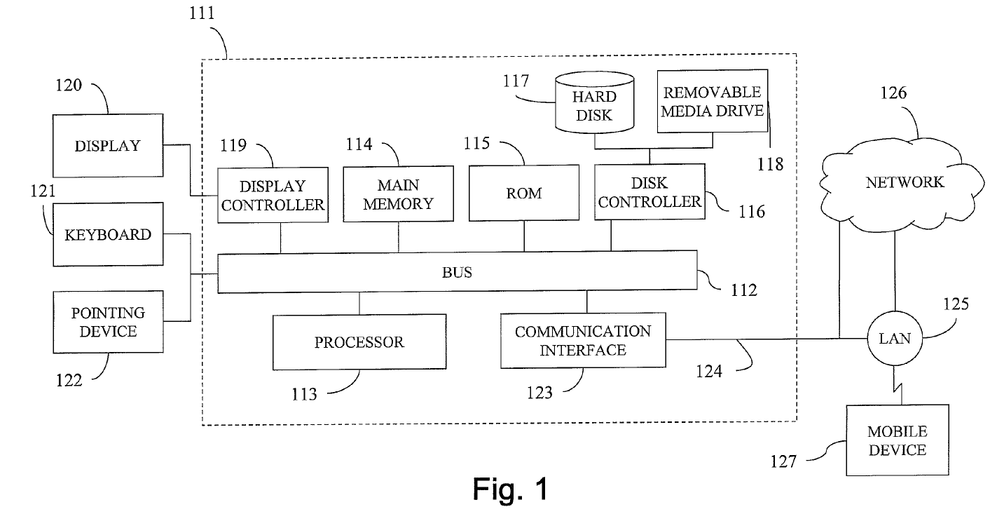

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer client 204. The computer system includes input devices, such as a keyboard 121 and a pointing device 122, for interacting with a computer client 204 and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client 204. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., a LAN) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

In one exemplary embodiment, a method and system for communicating are disclosed. The system may utilize any of a variety of communication devices, for example one or more wireless telephones, one or more traditional telephones, one or more devices capable of connecting to the Internet, one or more servers and one or more databases. Additionally, the system may allow for the communication of data or a message to one or more parties through the one or more wireless telephones, one or more devices capable of connecting to the Internet or one or more traditional telephones.

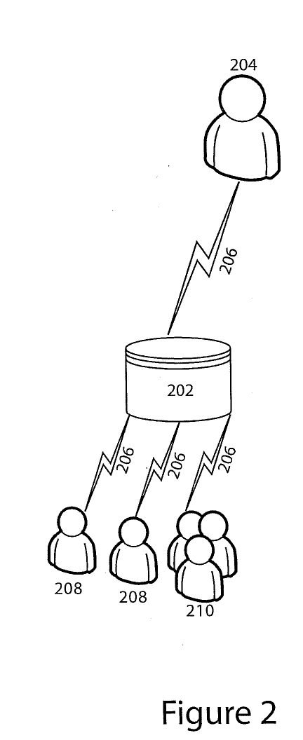

In one exemplary embodiment, as shown in FIG. 2, a database 202, similar to that described with respect to FIG. 1, may be accessed and data may be deposited within the database 202. The database 202 may be any type of known database and may be accessible in any known manner, for example through a communication link 206 between the database 202 and communication device or computer or combination thereof. Additionally, the database 202 may be capable of storing any of a variety of information in any of a variety of formats. For example, the database 202 may be capable of receiving information from a client 204 through the use of a communication service. The client 204 may connect to the database 202, for example using a personal computer, wireless telephone or personal digital assistant (PDA) (not pictured). The client 204 may then create a contact card for each of the client's intended message recipients. The client 204 may then submit any of a variety of contact information to the database 202 for each intended recipient 208. The contact information may include the recipient's name, address, telephone number or numbers, email, and any other desired data. The database 202 may also be compatible with a variety of standard electronic business card formats, such as, for example, the vCard format. The client 202 may also import contact information from an external database or electronic address book rather than inputting the contact information manually.

In a further exemplary embodiment, the client 204 may then create a message intended for distribution to a recipient or a plurality of recipients 208. The message may be a voice message, text message, picture message, or any other form of media message. The client 204 may then add the desired recipients 208 or groups of recipients 210 to the list of intended recipients of the message.

In one exemplary embodiment, the client 204 may enter a personal passcode for every recipient 208 in the client's contact list. The system may then contact each recipient 208 to inform the recipient of the passcode. In another exemplary embodiment, the system may create a randomly-generated passcode for each recipient 208 and may then contact each recipient to inform the recipient 208 of the passcode. In another exemplary embodiment, each recipient 208 may contact the system to manually create a passcode.

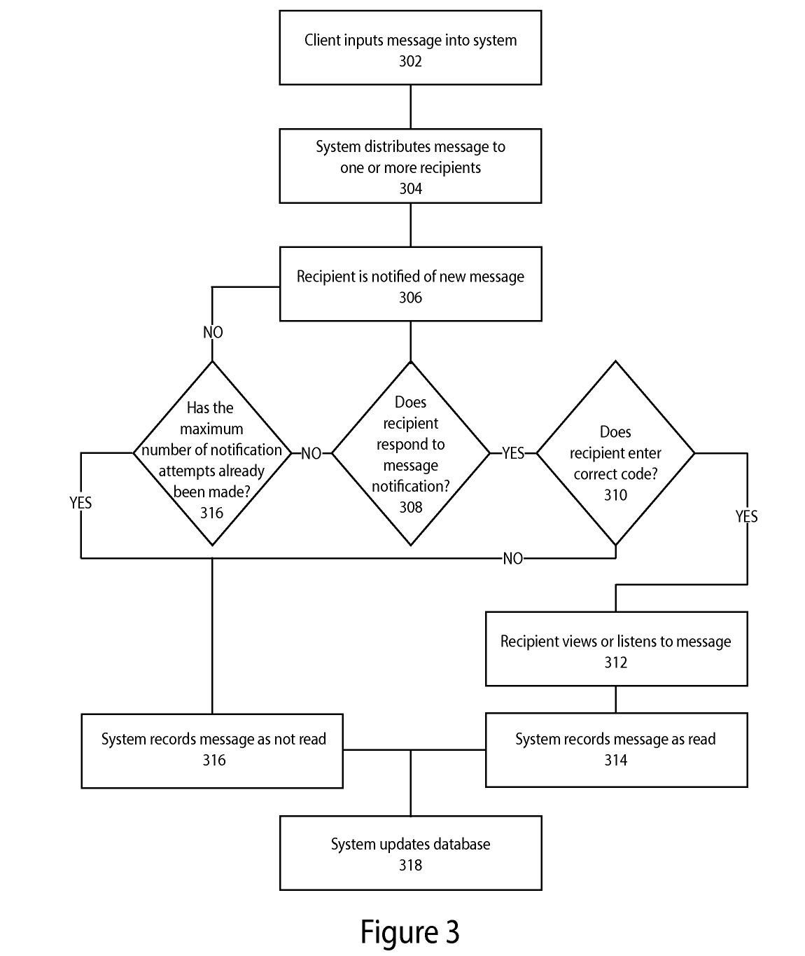

Referring to FIG. 3, the client 204 may input a message into the system for distribution, in step 302. The client 204 may dispatch the message for immediate distribution or schedule distribution for any predetermined date and time or period of time at which the client 204 may desire the message to be distributed. In step 304, the system may send out the message to the intended recipient 208 or plurality of recipients 208 at the time desired by client 204. Recipients 208 may be notified of an incoming message in step,306.

A recipient 208 may respond to a message notification in step 308. If a recipient 208 does not respond, the system may, in step 316, determine how many notification attempts have been made. If the amount of notification attempts made is less than a predetermined maximum number of notification attempts, the system may make further notification attempts until the number of notification attempts is equal to the predetermined maximum number. In one exemplary embodiment, the system may have the predetermined maximum number be equal to 4 by default. In another exemplary embodiment, the client may program the predetermined maximum number of notification attempts to be any desired number.

Upon receipt of a message notification, the recipient 208 may then enter a passcode to access the message. The system may determine in step 310 whether the passcode entered by the recipient 208 matches the stored passcode for that recipient. If the passcodes match, the system may then grant the recipient 208 access to the contents of the message in step 312.

In step 314, the system may then record that the intended recipient 208 has observed the contents of the message. The system may then, in step 318, update the database 202 to reflect that the intended recipient 208 has observed the contents of the message.

In another exemplary embodiment, the system may attempt to contact the intended recipient 208, but may not be able to communicate with the intended recipient 208 or may not receive a response from the intended recipient 208. The system may then make a repeat attempt to communicate with the intended recipient 208. This repeat notification attempt may occur at any time, for example a predetermined interval set by the client 204 or at a default time interval. Similar repeat notification attempts may be made at any predetermined or preset intervals. If the intended recipient 208 has not responded to the notifications after the maximum number of notification attempts, the system may, in step 316, record that the recipient 208 has not observed the contents of the message. In a further embodiment, if the intended recipient 208 has responded to a notification attempt and entered a passcode that does not match the stored passcode for that recipient, the system may, in step 316, record that the recipient has not observed the contents of the message. The system may then, in step 318, update the database 202 to reflect that the intended recipient 208 has not observed the contents of the message.

In further examples, the client 204 may access the system to obtain statistics on the messages sent through the system. In one exemplary embodiment, message statistics may include the number of recipients 208, the amount of messages received, the amount of delivery attempts for each message, and the amount of messages not received. In another exemplary embodiment, message statistics may include the amount of messages delivered in each delivery attempt, or any other desired information.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of communicating, comprising:
entering contact information into a database;
entering a message into the database;
setting conditions for a communication system associated with the database to communicate with a remotely located communication device;
communicating with the remotely located communication device by the communication system associated with the database when a first condition is met;
performing a first action when the remotely located communication device provides an appropriate response to the communication between the communication system associated with the database and the remotely located communication device;
performing a second action when the remotely located communication device provides an inappropriate response to the communication between the communication system associated with the database and the remotely located communication device; and
performing a third action when the remotely located communication device fails to provide a response to the communication between the communication system associated with the database and the remotely located communication device.

2. The method of claim 1, wherein the first condition is one of the passage of a predetermined amount of time or the arrival of a predetermined time and date.

3. The method of claim 1, wherein the communication between the communication system associated with the database and the remotely located communication device further comprises:
requesting confirmation data from the remotely located communication device.

4. The method of claim 1, wherein the third action further comprises:
attempting communication with the remotely located communication device at predetermined intervals until a second condition is met.

5. The method of claim 4, wherein the second condition is one of the providing of a response from the remotely located communication device to the communication system associated with the database or a predetermined number of attempts to communicate between the remotely located communication device and the communication system associated with the database.

6. The method of claim 1, wherein the remotely located communication device is a wireless telephone.

7. The method of claim 1, wherein the communicating between the remote located communication device and the communication system associated with the database is a telephone call.

8. The method of claim 1, wherein the communicating between the remote located communication device and the communication system associated with the database is a SMS message.

9. A system for communication, comprising:
a database that houses data;
a first communication device that communicates with the database through a second communication device, the first communication device provides data to the database, the database houses the data provided by the first communication device; and
a second communication device that accesses data in the database and communicates with the first communication device;
wherein the second communication device retrieves information from the database and attempts to communicate with the first communication device at predetermined intervals.

10. The communication system of claim 9, wherein the second communication device relays a communication to the first communication device upon receipt of an appropriate response from the first communication device.

11. The communication system of claim 10, wherein the first communication device and the second communication device communicate through a telephone system.
